(19) United States
(12) Patent Application Publication
(10) Pub. No.: US 2008/0133905 A1
(43) Pub. Date: Jun. 5, 2008

(54) APPARATUS, SYSTEM, AND METHOD FOR REMOTELY ACCESSING A SHARED PASSWORD

(76) Inventors: David Carroll Challener, Raleigh, NC (US); Seiichi Kawano, Sagamihara (JP); Randall Scott Springfield, Chapel Hill, NC (US); Rod D. Waltermann, Rougemont, NC (US)

Correspondence Address: Kunzler & McKenzie, 8 EAST BROADWAY, SUITE 600, SALT LAKE CITY, UT, 84111, US

(21) Appl. No.: 11/565,452

(22) Filed: Nov. 30, 2006

(51) Int. Cl. H04L 9/32

(52) U.S. Cl. 713/156

(57) ABSTRACT

An apparatus, system, and method are disclosed for remotely accessing a shared password. A storage module stores identifiers, passwords, and keys within a secure key structure of a client. The passwords and keys include a shared password encrypted with a shared password key that is encrypted with a service structure key. The storage module also stores the service structure key encrypted with a key derived from a service password on a trusted server. An input/output module accesses the trusted server from the client with a prospective service password and receives the encrypted service structure key from the trusted server if a hash of the prospective service password is equivalent to the service password. An encryption module may decrypt the service structure key with the prospective service password, the shared password key with the service structure key, and the shared password with the shared password key.

### BACKGROUND OF THE INVENTION

1. Field of the Invention

This invention relates to shared passwords and more particularly relates to remotely accessing a shared password.

2. Description of the Related Art

Computers are being used to store and access increasing amounts of sensitive and valuable information. For example, a laptop may be used to store and manipulate large databases comprising sensitive customer information. In addition, a computer may be configured to access additional information from remote servers. For example, the laptop mentioned above may be configured to access a remote database of corporate financial data, remote product design files, and the like.

Computers may also store valuable personal information. For example, a computer user may access personal bank accounts, retail accounts, and sensitive personal information from the computer using cookies and/or files stored by a web-based application on the computer. The cookies may store account numbers, passwords, and the like.

Unfortunately, laptop computers are often lost or stolen. A malicious user in an office or even in a home may also access computer workstations. As a result, passwords that grant access to computers are becoming increasingly popular.

Passwords are commonly set for the Basic Input/Output System (BIOS) and the hard disk drive of a computer such as a laptop computer or computer workstation so that the BIOS and the hard disk drive cannot be used unless the set passwords are properly entered. When a laptop and/or computer workstation with password settings is started, the computer prompts for entry of a password. If the password is entered and properly authenticated, the computer may boot to an active state.

Unfortunately, the user of a computer is often not the only person that requires access to the computer. For example, servicers such as information technology personnel, as well as colleagues may need to access a password-protected computer. Shared passwords have been used to allow servicers and colleagues to access computers. Unfortunately, a servicer who is servicing hundreds of computers may not have ready access to the shared password of each computer. In addition, it may be advantageous that shared passwords are not valid indefinitely.

### SUMMARY OF THE INVENTION

From the foregoing discussion, there is a need for an apparatus, system, and method that remotely accesses a shared password. Beneficially, such an apparatus, system, and method would allow servicers and others to retrieve the shared password for a client from a trusted server.

The present invention has been developed in response to the present state of the art, and in particular, in response to the problems and needs in the art that have not yet been fully solved by currently available shared password methods. Accordingly, the present invention has been developed to provide an apparatus, system, and method for remotely accessing a shared password that overcome many or all of the above-discussed shortcomings in the art.

The apparatus to remotely access a shared password is provided with a plurality of modules configured to functionally execute the steps of storing identifiers, keys, passwords in a secure key structure, storing a service structure key on a trusted server, accessing the trusted server, receiving the service structure key at the client, and decrypting the service structure key. These modules in the described embodiments include a storage module, an input/output (I/O) module, and an encryption module.

The storage module stores an account identifier, a servicer identifier that identifies a servicer, a server identifier for a trusted server, a shared password key encrypted with a service structure key, a shared password encrypted with the shared password key, and service identifier structure within a secure key structure of a client. The secure key structure comprises a password policy for accessing data within the secure key structure. In addition, the service identifier structure includes the shared password key. The storage module also stores the service structure key encrypted with a key derived from the service password maintained on the trusted server.

The I/O module accesses the trusted server from the client using the server identifier in response to receiving the account identifier, the servicer identifier and a prospective service password at the client. In addition, the I/O module receives at the client the encrypted service structure key, an access limit, and a date limit from the trusted server if the prospective service password is equivalent to the service password maintained on the trusted server.

The encryption module decrypts the encrypted service structure key at the client using the prospective service password. In one embodiment, the encryption module also decrypts the encrypted shared password key from the service identifier structure with the decrypted service structure key, decrypts the shared password with the decrypted shared password key, and grants access to the client in response to the shared password. The apparatus accesses the shared password by retrieving the service structure key so that a servicer and/or other authorized personnel may access the client.

A system of the present invention is also presented to remotely access a shared password. The system may be embodied in a data processing system. In particular, the system, in one embodiment, includes trusted server, a network, and a client.

The trusted server includes an account data structure. The trusted server communicates with the client through the network. The client includes a secure key structure, a storage module, an I/O module, and an encryption module.

The storage module stores an account identifier, a servicer identifier that identifies a servicer, a server identifier for the trusted server, a shared password key encrypted with a service structure key, a shared password encrypted with the shared password key, and a service identifier structure within the secure key structure. The secure key structure comprises a password policy for accessing data within the secure key structure. In addition, the service identifier structure includes the shared password key. The storage module also stores the service structure key encrypted with a key derived from the service password maintained in the account data structure.

The I/O module accesses the trusted server from the client using the server identifier in response to receiving the account identifier, the servicer identifier and a prospective service password at the client. In addition, the I/O module receives at the client the encrypted service structure key, an access limit, and a date limit from the trusted server if the prospective service password is equivalent to the service password maintained on the trusted server.

The encryption module decrypts the encrypted service structure key using the prospective service password. In one embodiment, the encryption module also decrypts the encrypted shared password key from the service identifier structure with the decrypted service structure key, decrypts the shared password with the decrypted shared password key, and grants access to the client in response to the shared password. The system accesses the shared password by remotely accessing the service structure key so that a servicer and/or other authorized personnel may access the client.

A method of the present invention is also presented for remotely accessing a shared password. The method in the disclosed embodiments substantially includes the steps to carry out the functions presented above with respect to the operation of the described apparatus and system. In one embodiment, the method includes storing identifiers, keys, passwords in a secure key structure, storing a service structure key on a trusted server, accessing the trusted server, receiving the service structure key at the client, and decrypting the service structure key.

A storage module stores an account identifier, a servicer identifier that identifies a servicer, a server identifier for a trusted server, a shared password key encrypted with a service structure key, a shared password encrypted with the shared password key, and a service identifier structure within a secure key structure of a client. The secure key structure comprises a password policy for accessing data within the secure key structure. In addition, the service identifier structure includes the shared password key. The storage module also stores the service structure key encrypted with a key derived from the service password maintained on the trusted server.

An I/O module accesses the trusted server from the client using the server identifier in response to receiving the account identifier, the servicer identifier and a prospective service password at the client. In addition, the 1/0 module receives at the client the encrypted service structure key, an access limit, and a date limit from the trusted server if the prospective service password is equivalent to the service password maintained on the trusted server.

An encryption module decrypts the encrypted service structure key at the client using the prospective service password. In one embodiment, the encryption module also decrypts the encrypted shared password key from the service identifier structure with the decrypted service structure key, decrypts the shared password with the decrypted shared password key, and grants access to the client in response to the shared password. The method accesses the shared password so that a servicer may access the client.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The present invention allows a servicer to access a shared password using a service structure key remotely obtained from a trusted server. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a data processing system in accordance with the present invention;

FIG. 2 is a schematic block diagram illustrating one embodiment of a secure key structure of the present invention;

FIG. 3 is a schematic block diagram illustrating one embodiment of a trusted server of the present invention;

FIG. 4 is a schematic block diagram illustrating one embodiment of a shared password apparatus of the present invention;

FIG. 5 is a schematic flow chart diagram illustrating one embodiment of a password access method of the present invention;

FIG. 6 is a schematic flow chart diagram illustrating one embodiment of a single/multiple access method of the present invention;

FIG. 7 is a schematic flow chart diagram illustrating one embodiment of an access limitation method of the present invention; and

FIG. 8 is a schematic flow chart diagram illustrating one embodiment of a service structure key creation method of the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

As used herein a key refers to a number of any number of digits such as a one hundred twenty eight (128) digit number. The number may be random number, pseudo random number, or the like. As used herein, a password refers to a string of characters. Passwords and keys may be used to encrypt and decrypt passwords and keys, as well as grant access to services, devices, and the like. As used herein, encryption refers to encoding passwords, keys, digital data, and the like with a password and/or key. The encoding may include mathematical operations, logical operations, and the like that are performed on the passwords, keys, and digital data to disguise the passwords, keys, and digital data. Decryption as used herein refers to decoding encrypted data so that the encoded data is not disguised. Encrypted data is shown in the drawings surrounded by a broken line box that includes the name of the encryption key or password.

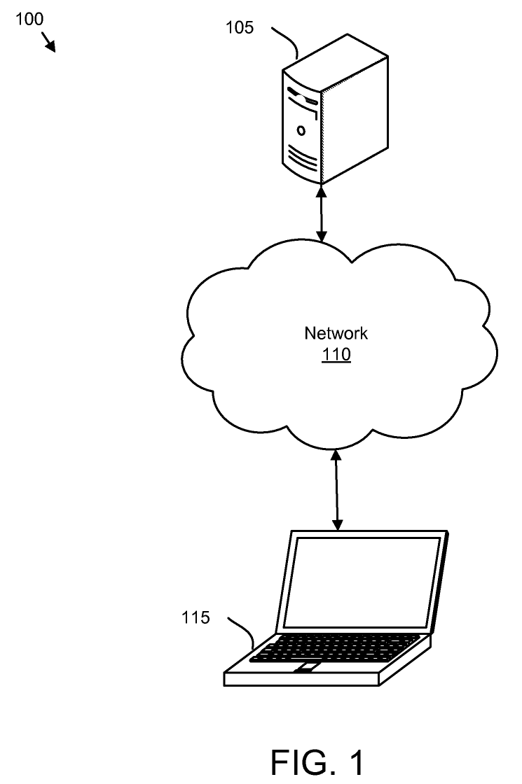

FIG. 1 is a schematic block diagram illustrating one embodiment of a data processing system 100 in accordance with the present invention. The system 100 includes a trusted server 105, a network 110, and a client 115. Although for simplicity only one trusted server 105, one network 110, and one client 115 are shown, any number of trusted servers 105, networks 110, and laptop computers 115 may be employed.

The network 110 may be configured as the Internet, a wide area network (WAN), a local area network (LAN), a wireless network, and the like. The trusted server 105 may be a server, a blade server, a mainframe computer, or the like. Although a client 115 is depicted as laptop computer, one of skill in the art will recognize that the client 115 may also be a computer workstation, personal digital assistant (PDA), cellular telephone, and the like.

The client 115 and/or a storage device of the client 115 such as a hard disk drive may be protected with a shared password. A user may use the shared password to access the client 115. Alternatively, the user may use a personal password to access the shared password, and the shared password may give the user access to the client 115. As used herein, accessing the client 115 may refer to allowing the client 115 to boot, enabling I/O with the client 115, and/or accessing storage device of the client 115.

Occasionally, a servicer may also require access to the client 115. For example, the servicer may need to install new software on the client 115. If the servicer carried the shared passwords for some or all of the computers that the servicer might need to access, the security of the system 100 and the client 115 is put at risk as the shared passwords may be lost and/or stolen. The present invention allows the servicer to remotely access the shared password using a service structure key from the trusted server 105 so that the servicer may access the client 115 as will be described hereafter. In addition, the present invention may limit the number of accesses with the shared password and/or the time period that the shared password may be used.

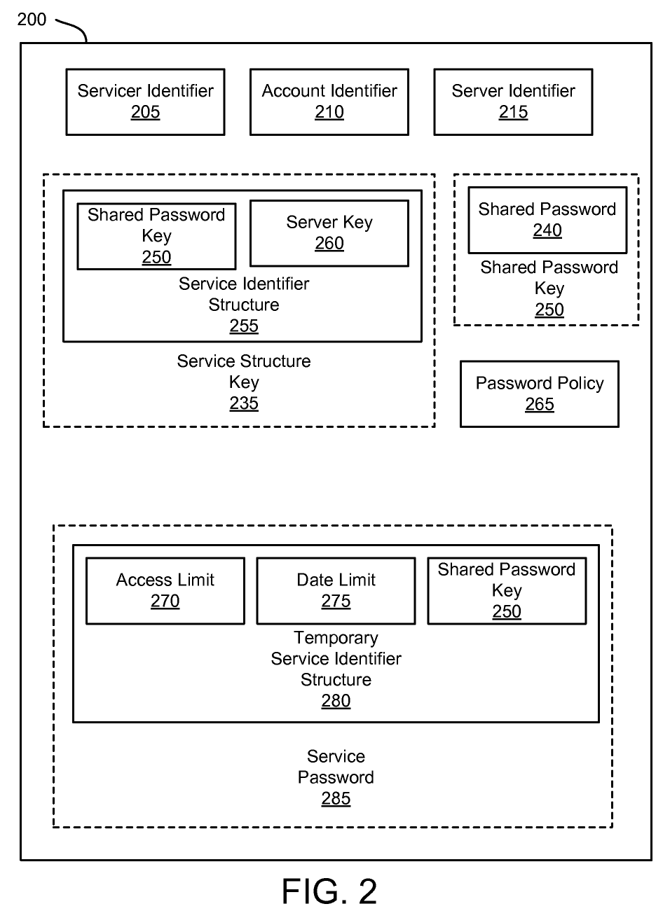

FIG. 2 is a schematic block diagram illustrating one embodiment of a secure key structure 200 of the present invention. The secure key structure 200 resides on the client 115 of FIG. 1. The description of the secure key structure 200 refers to elements of FIG. 1, like numbers referring to like elements. The secure key structure 200 includes a servicer identifier 205, an account identifier 210, a server identifier 215, a shared password 240, a shared password key 250, a service identifier structure 255, a service structure key 235, a server key 260, a password policy 265, an access limit 270, and a date limit 275. The secure key structure 200 may also include a temporary service identifier structure 280 and a prospective service password 285.

In one embodiment, the secure key structure 200 resides in a security module of the client 115 such as a Trusted Platform Module (TPM) as defined by the Trusted Computing Group. The secure key structure 200 may be encrypted with one or more keys.

The account identifier 210 identifies the client 115 and the secure key structure 200. For example, the account identifier 210 may be the client's Internet protocol (IP) address. The server identifier 215 identifies the trusted server 105. For example, the server identifier 215 may be the trusted server's IP address. In addition, the servicer identifier 205 identifiers an authorized servicer.

The shared password 240 grants access to the client 115. In one embodiment, the shared password 240 is required for the BIOS to boot the client 115. Alternatively, the shared password 240 may unlock a storage device such as a hard disk drive. In a certain embodiment, the shared password 240 accesses remote services such as a remote database.

The shared password 240 is encrypted with a shared password key 250. The shared password key 250 is stored in the service identifier structure 255. The service identifier structure 255 is encrypted with the service structure key 235.

The service identifier structure 255 may also include the server key 260. In one embodiment, the server key 260 is used to encrypt and decrypt communications to and from the trusted server 105. Although for simplicity one server key 260 is shown, the service identifier structure 255 may include a plurality of server keys 260. The password policy 265 may define limits to data with the secure key structure 200 such as the shared password key 250 as will be described hereafter.

In one embodiment, the secure key structure 200 may include the temporary service identifier structure 280. The temporary service identifier structure 280 may be encrypted with the service password 285 that will be described hereafter. The service password 285 may be equivalent to a prospective service password that will be described hereafter. The temporary service identifier structure 280 may include the access limit 270 and the date limit 275.

In one embodiment, the access limit 270 is a count value. The count value may specify a number of times the servicer may access the client 115. For example, if the access limit 270 is the value three (3), the servicer may access the client 115 three times using a prospective service password. The servicer may be unable to access the client 115 if the access limit 270 is zero (0). One of skill in the art will recognize that other counting and count limit techniques may also be sued for the access limit 270.

The date limit 275 may be a date beyond which the servicer may not access the client 115. For example, if the date limit 275 is Mar. 9, 2011, the servicer may not access the client 115 after Mar. 9, 2011. In one embodiment, the password policy 265 specifies an access limit maximum and a date limit maximum. For example, the password policy 265 may specify that the access limit 270 cannot exceed twelve (12) accesses. Thus a servicer may be granted nine (9) accesses, but not fifteen (15) accesses. Similarly, the password policy 275 may specify that the date limit 275 may not be set to a date beyond forty-five (45) days from a current date.

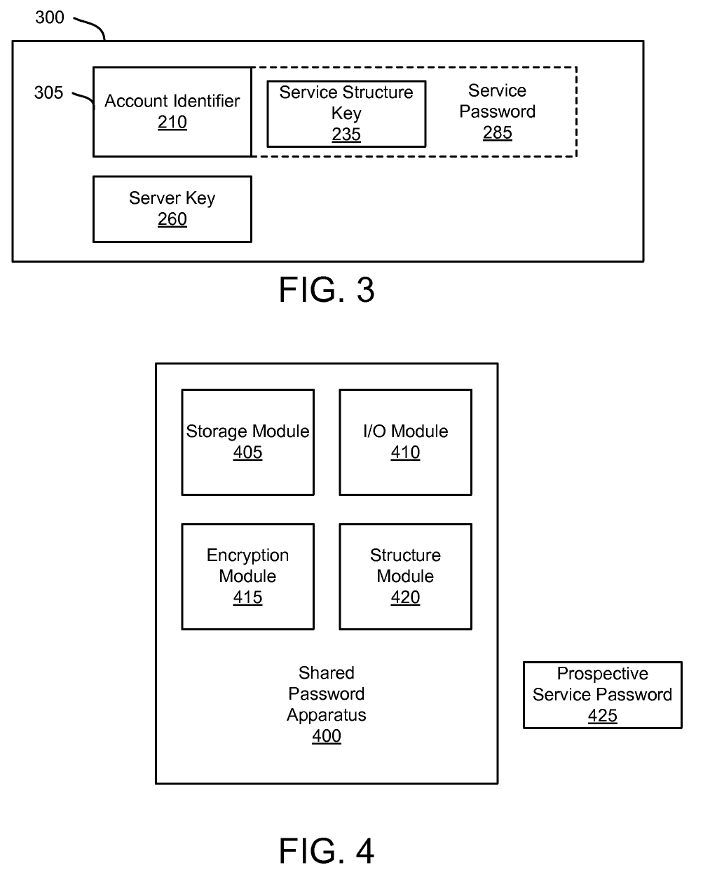

FIG. 3 is a schematic block diagram illustrating one embodiment of a trusted server 300 of the present invention. The trusted server 300 is a schematic representation of elements of the trusted server 105 of FIG. 1. The description of the trusted server 300 refers to elements of FIGS. 1-2, like numbers referring to like elements.

The trusted server 300 includes an account data structure 305. In one embodiment, the trusted server 300 includes an account data structure 305 for each client 115, computer workstation, and the like in communication with the trusted server 300. The account data structure includes the account identifier 210, and the service structure key 235 encrypted with a key derived from the service password 285. The service password 285 may allow the servicer to access the service structure key 235 for the client 115 of the account identifier 210 as will be described hereafter. In one embodiment, the server key 260 encrypts and decrypts communications between the trusted server 300 and the secure key structure 200.

FIG. 4 is a schematic block diagram illustrating one embodiment of a shared password apparatus 400 of the present invention. The apparatus 400 includes a storage module 405, an I/O module 410, an encryption module 415, and a structure module 420. A prospective service password 425 is also shown. The description of the apparatus 400 refers to elements of FIGS. 1-3, like numbers referring to like elements. In one embodiment, the apparatus is embodied in the client 115.

The prospective service password 425 is a password received from a servicer. The prospective service password 425 may be the service password 285. For example, if the servicer is privy to the service password 425, the servicer may employ a prospective service password 425 that is equivalent to the service password 425.

The storage module 405 stores the account identifier 210, the servicer identifier 205, the server identifier 215, the shared password key 250 encrypted with the service structure key 235, the shared password 240 encrypted with the shared password key 250, and the service identifier structure 255 within the secure key structure 200. The storage module 405 also stores the service structure key 235 encrypted with a key derived from the service password 285 in the account data structure 305 on the trusted server 105.

The I/O module 410 accesses the trusted server 105 from the client 115 using the server identifier 215 in response to receiving the account identifier 210, the servicer identifier 205, and the prospective service password 425 at the client 115. In addition, the I/O module 410 receives at the client 115 the encrypted service structure key 235, the access limit 270, and the date limit 275 from the trusted server 105 if a hash of the prospective service password 425 is equivalent to the service password 285 maintained on the trusted server 105. The encrypted service structure key 235, the access limit 270, and the date limit 275 may be encrypted with service password 285/prospective service password 425.

The encryption module 415 decrypts the encrypted service structure key 235 at the client 115 using the prospective service password 285. In one embodiment, the encryption module 415 also decrypts the encrypted shared password key 250 from the service identifier structure 255 with the decrypted service structure key 235, decrypts the shared password 240 with the decrypted shared password key 250, and grants access to the client 115 in response to the shared password 240.

In one embodiment, the structure module 420 creates the temporary service identifier structure 280 with data from the service identifier structure 255. The data may include the shared password key 250. The apparatus 400 accesses the shared password 240 by retrieving the service structure key 235 so that the servicer and/or other authorized personnel may access the client 115.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

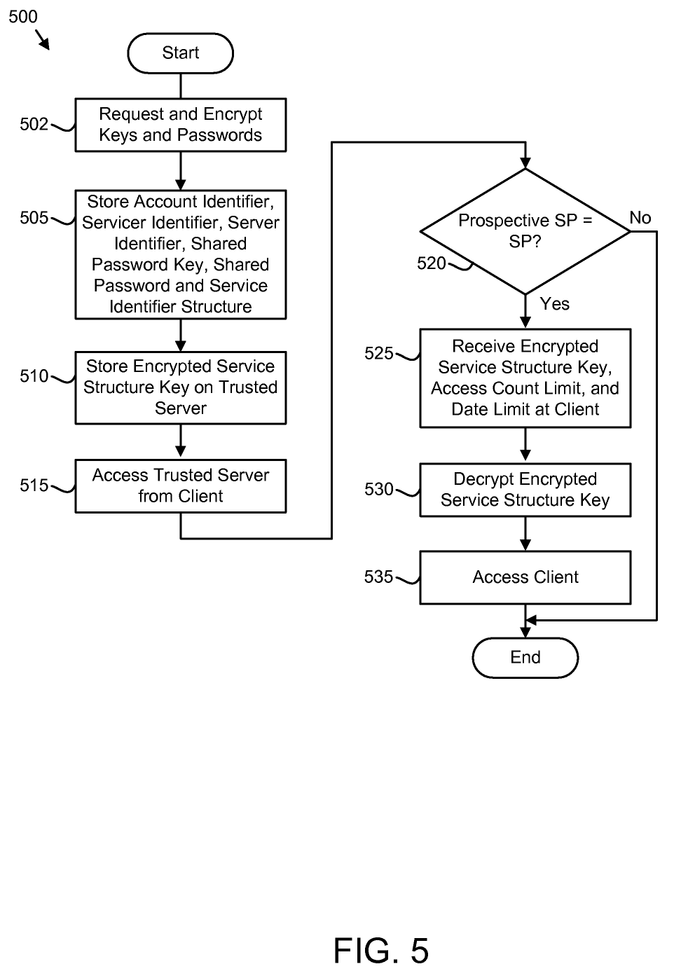

FIG. 5 is a schematic flow chart diagram illustrating one embodiment of a password access method 500 of the present invention. The method 500 substantially includes the steps to carry out the functions presented above with respect to the operation of the described apparatus and system of FIGS. 1-4. In one embodiment, the method 600 is implemented with a computer program product comprising a computer readable medium having a computer readable program. The client 115 executes the computer readable program. Alternatively, the trusted server 105 may execute portions of the computer readable program.

The method 500 begins, and in one embodiment, the encryption module 415 requests 502 the shared password 240, shared password key 250, and service structure key 235. The encryption module 415 may request the shared password 240, shared password key 250, and service structure key 235 from a TPM. In a certain embodiment, the encryption module 415 generates the shared password 240, shared password key 250, and service structure key 235 using a random number generator. The encryption module 415 may also encrypt the shared password key 250 with the service structure key 235 and the shared password 240 with the shared password key 250.

The storage module 405 stores 505 the account identifier 210, the servicer identifier 205, the server identifier 215, the shared password key 250 encrypted with the service structure key 235, the shared password 240 encrypted with the shared password key 250, and the service identifier structure 255 within the secure key structure 200. In one embodiment, the storage module 405 receives the account identifier 210, the servicer identifier 205, and the server identifier 215 through the I/O module 410 from the trusted server 105. The storage module 405 may receive the account identifier 210, the servicer identifier 205, and the server identifier 215 encrypted with the server key 260 and the encryption module 415 may decrypt the account identifier 210, the servicer identifier 205, and the server identifier 215.

The storage module 405 also stores 510 the service structure key 235 encrypted with a key derived from the service password 285 in the account data structure 305 on the trusted server 105. The storage module 405 may communicate the encrypted service key 235 through the I/O module 410.

The I/O module 410 accesses 515 the trusted server 105 from the client 115 using the server identifier 215 in response to receiving the account identifier 210, the servicer identifier 205, and the prospective service password 425 at the client 115. For example, the servicer may activate the client 115 and enter servicer identifier 205 and the prospective service password 425 at a keyboard of the client 115. The I/O module 410 may verify the servicer identifier 205 and communicate the account identifier 210, the servicer identifier 205, and the prospective service password 425 to the trusted server 105. In one embodiment, the account identifier 210, the servicer identifier 205, and the prospective service password 425 are encrypted with the server key 260.

The trusted server 105 may determine 520 if a hash of the prospective service password 425 is equivalent to the service password 285 maintained in the account data structure 305 on the trusted server 105. If the trusted server 105 determines 520 that the hash of the prospective service password 425 is not equivalent to the service password 285, the method 500 terminates with the secure key structure 200 not receiving the service structure key 235.

If the trusted server 105 determines 520 that the prospective service password 425 is equivalent to the service password 285, the I/O module 410 receives 525 at the client 115 the encrypted service structure key 235, the access limit 270, and the date limit 275 from the trusted server 105. The service structure key 235, the access limit 270, and the date limit 275 may be encrypted with the prospective service password 425.

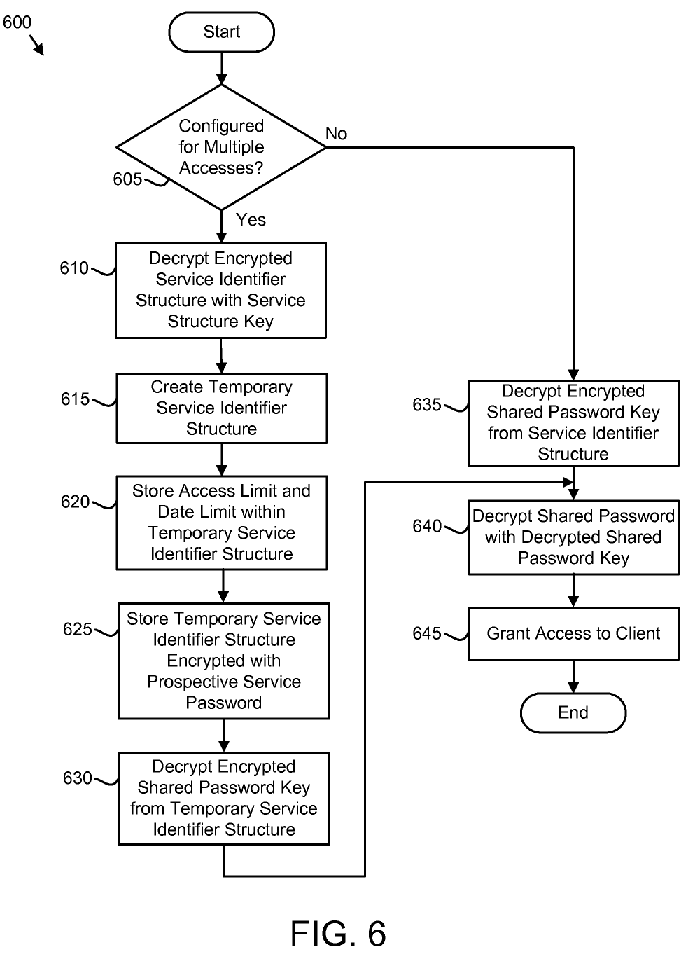

The encryption module 415 decrypts 530 the encrypted service structure key 235 at the client 115 using the prospective service password 425. In one embodiment, the encryption module 415 also decrypts the encrypted shared password key 250 from the service identifier structure 255 with the decrypted service structure key 235, decrypts the shared password 240 with the decrypted shared password key 250, and accesses 535 the client 115 with the shared password 240. One embodiment of step 535 is described hereafter for FIG. 6.

The method 500 allows the servicer to access the shared password 240 using the service structure key 235 from the trusted server 105. Thus the servicer may gain access to the client 115 through the shared password 240 although the servicer and the trusted server 105 do not posses the shared password 240. The method 500 provides security to the client 115 while giving the servicer a means of accessing the client 115.

FIG. 6 is a schematic flow chart diagram illustrating one embodiment of a single/multiple access limitation method 600 of the present invention. The method 600 substantially includes the steps to carry out the functions presented above with respect to the operation of the described apparatus and system of FIGS. 1-4 and step 535 of FIG. 5. In one embodiment, the method 600 is implemented with a computer program product comprising a computer readable medium having a computer readable program. The client 115 executes the computer readable program. Alternatively, the trusted server 105 may execute portions of the computer readable program.

The method 600 begins and in one embodiment, the encryption module 415 determines 605 if the access limit 270 and date limit 275 are configured for multiple accesses. In one embodiment, the access limit 270 and date limit 275 are configured for multiple accesses if the access limit 270 is greater than one.

If the encryption module 415 determines 605 that the access limit 270 and date limit 275 are not configured for multiple accesses, the encryption module 415 may decrypt 635 the encrypted shared password key 250 from the service identifier structure 255 with the decrypted service structure key 235. In addition, the encryption module 415 may decrypt 640 the shared password 240 with the decrypted shared password key 250. The encryption module 415 may further grant 645 access to the client 115 in response to the shared password 240 and the method 600 terminates. For example, the encryption module 415 may supply the shared password 240 to the BIOS, enabling the BIOS to boot the client 115. Alternatively, the encryption module 415 may supply the shared password 240 to the storage device to unlock the storage device.

If the encryption module 415 determines 605 that the access limit 270 and date limit 275 are configured for multiple accesses, the encryption module 415 may decrypt 610 the encrypted service identifier structure 255 with the decrypted service structure key 235. The structure module 420 may create 615 the temporary service identifier structure 280 with the shared password key 250 from the service identifier structure 255.

In one embodiment, the storage module 405 stores 620 the access limit 270 and the date limit 275 within the temporary service identifier structure 280. In addition, the storage module 420 may store 625 the temporary service identifier structure 280 encrypted with the service password 285/prospective service password 425 in the secure key structure 200.

The encryption module 415 may decrypt 630 the encrypted shared password key 250 from the temporary service identifier structure 280 with the prospective service password 425. In addition, the encryption module 415 may decrypt 640 the shared password 240 with the decrypted shared password key 250, and grant access to the client 115 as described above and the method 600 terminates.

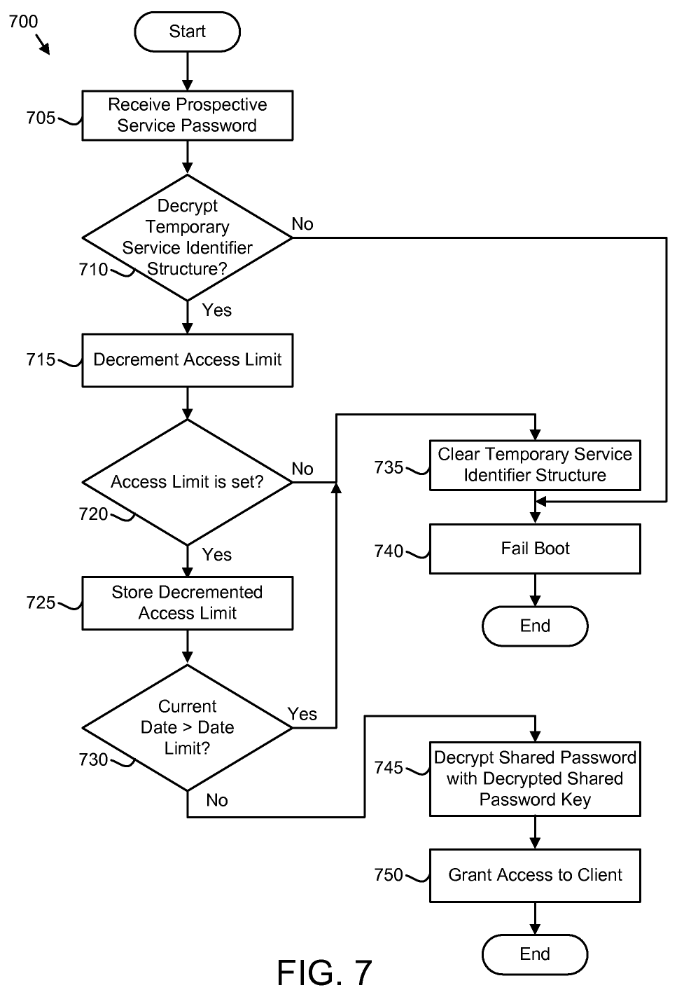

The temporary service identifier structure 280 preserves the access limit 270 and the date limit 275. If, for example, the servicer again accesses the client 115 using the prospective service password 425, the present invention may verify that the servicer's access privilege as specified by the access limit 270 and date limit 275 is still valid as will be described in the description of FIG. 7.

FIG. 7 is a schematic flow chart diagram illustrating one embodiment of an access limitation method 700 of the present invention. The method 700 substantially includes the steps to carry out the functions presented above with respect to the operation of the described apparatus and system of FIGS. 1-4 and steps 525 and 530 of FIG. 5 for a subsequent attempt by the servicer to access the client 115. In one embodiment, the method 700 is implemented with a computer program product comprising a computer readable medium having a computer readable program. The client 115 executes the computer readable program. Alternatively, the trusted server 105 may execute portions of the computer readable program.

The method 700 begins and in one embodiment, the I/O module 410 receives 705 the prospective service password 425 entered by the servicer at the client 115. The encryption module 415 determines 710 if the prospective service password 425 may decrypt 710 the shared password key 250 by using the prospective service password 425 to decrypt the temporary service identifier structure 280. The prospective service password 425 decrypts the temporary service identifier structure 280 if the prospective service password 425 is equivalent to the service password 285, indicated a prior access to the client 115 using the service structure key 235.

In one embodiment, if the encryption module 415 determines 710 that the prospective service password 425 will not decrypt 710 the shared password key 250, the encryption module 415 may fail 740 the boot of the client 115 and the method 700 terminates. The encryption module 415 may fail 740 the boot by not communicating the shared password 240 to the BIOS.

If the encryption module 415 determines 710 that the prospective service password 425 may decrypt 710 the shared password key 250, the encryption module 415 may decrement 715 the access limit 270. For example, if the access limit 270 is the value seven (7), the encryption module 415 may decrement the access limit 270 to the value six (6).

The encryption module 415 may further determine 720 if the access limit 270 is set. In one embodiment, the access limit 270 is set if the access limit 270 is greater than zero (0). If the access limit 270 is not set, the encryption module 415 may clear 735 the temporary service identifier structure 280. In one embodiment, the encryption module 415 clears 735 the temporary service identifier structure 280 by overwriting the temporary service identifier structure 280 in the secure key structure 200. The encryption module 415 may also fail 740 the boot of the client 115 as described above.

If the encryption module 415 determines 720 that the access limit 270 is set, the storage module 725 may store 725 the decremented access limit 270 in the encrypted temporary service identifier structure 280.

In one embodiment, the encryption module 415 further determines 730 if a current date is greater than the date limit 275. For example, if the current date is Jan. 4, 2010 and the date limit 275 is Jan. 10, 2010, then the current date is not greater than the data limit 275.

If the encryption module 415 determines 730 that the current date is greater than the date limit 275, the encryption module 415 may clear 735 the temporary service identifier structure 280 and fail 740 the boot of the client 115 as described above. If the encryption module 415 determines 730 that the current date is less than and/or equivalent to the date limit 275, the encryption module 415 may decrypt 745 the shared password 240 with the decrypted shared password key 250 obtained from the temporary service identifier structure 280 and grant 750 access to the client 115 and the method 700 ends.

The method 700 determines if the servicer is authorized to access the client 115. In addition, the method 700 determines when the servicer's authorization should end. Thus a servicer and/or colleague of a user of the client 115 may be granted a number of accesses as specified by the access limit 270 and/or access for a time period as specified by the date limit 275. However, when the access limit 270 and/or date limit 275 is exceeded, access to the client 115 is denied.

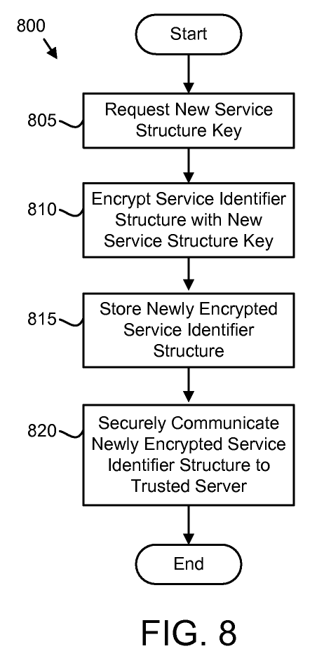

FIG. 8 is a schematic flow chart diagram illustrating one embodiment of a service structure key creation method 800 of the present invention. The method 800 substantially includes the steps to carry out the functions presented above with respect to the operation of the described apparatus and system of FIGS. 1-4 and steps 502 and 505 of FIG. 5. In one embodiment, the method 800 is implemented with a computer program product comprising a computer readable medium having a computer readable program. The client 115 executes the computer readable program. Alternatively, the trusted server 105 may execute portions of the computer readable program.

The method 800 begins and in one embodiment, the encryption module 415 requests 805 a new service structure key 235. The encryption module 415 may request 805 the new service structure key 235 if the access limit 270 is less than or equal to zero (0). Alternatively, the encryption module 415 may request 805 the new service structure key 235 if the current date is greater than the date limit 275. In one embodiment, the user of the client 115 must agree to the initiation of the request.

In a certain embodiment, the encryption module 415 requests 805 the new service structure key 235 in response to the password policy 265. For example, the password policy 265 may require a new service structure key 235 every thirty (30) days. In an alternate embodiment, the encryption module 415 may request the new service structure key 235 from the trusted server 105. In one embodiment, the encryption module 415 receives the new service structure key 235 and encrypts 810 the service identifier structure 255 with the new service structure key 235.

In one embodiment, the storage module 405 stores 815 the newly encrypted service identifier structure 255 in the secure key structure 200. The I/O module 410 may securely communicate 820 the new service structure key 235 to the trusted server 105. In one embodiment, the new service structure key 235 is encrypted with a key derived from the service password 285 and communicated 820 to the trusted server 105.

The present invention allows the servicer to access the shared password 240 using the service structure key 235 remotely obtained from the trusted server 105. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to remotely access a shared password, the apparatus comprising:
a storage module configured to store an account identifier, a servicer identifier that identifies a servicer, a server identifier for a trusted server, a shared password key encrypted with a service structure key, a shared password encrypted with the shared password key, and a service identifier structure within a secure key structure of a client wherein the secure key structure comprises a password policy for accessing data within the secure key structure and the service identifier structure comprises the shared password key, the storage module further configured to store the service structure key encrypted with a key derived from a service password on the trusted server;
an input/output (I/O) module configured to access the trusted server from the client using the server identifier in response to receiving the account identifier, the servicer identifier and the prospective service password at the client and receive at the client the encrypted service structure key, an access limit, and a date limit from the trusted server if a hash of the prospective service password is equivalent to the service password maintained on the trusted server; and
an encryption module configured to decrypt the encrypted service structure key at the client using the prospective service password.

2. The apparatus of claim 1, wherein the encryption module is further configured to decrypt the encrypted shared password key from the service identifier structure with the decrypted service structure key, decrypt the shared password with the decrypted shared password key, and grant access to the client in response to the shared password if the access limit and the date limit are configured for a single access.

3. The apparatus of claim 1, the apparatus further comprising a structure module and wherein the encryption module is further configured to decrypt the encrypted service identifier structure with the decrypted service structure key, the structure module is configured to create a temporary service identifier structure with the shared password key from the service identifier structure, the storage module is further configured to store the access limit and the date limit within the temporary service identifier structure and store the temporary service identifier structure encrypted with the prospective service password, and the encryption module is configured to decrypt the encrypted shared password key from the temporary service identifier structure with the prospective service password, decrypt the shared password with the decrypted shared password key, and grant access to the client in response to the shared password if the access limit and date limit are configured for multiple accesses.

4. The apparatus of claim 3, wherein the I/O module is further configured to receive the prospective service password entered by the servicer, the encryption module is configured to decrypt the shared password key by using the prospective service password to decrypt the temporary service identifier structure, fail a boot if the shared password key and temporary service identifier structure cannot be decrypted, decrement the access limit if the access limit greater is set, clear the temporary service identifier structure and fail the boot if the access limit is not set else store the decremented access limit in the encrypted temporary service identifier structure, clear the temporary service identifier structure and fail the boot if the current date is greater than the date limit in the temporary service identifier structure, and the encryption module is further configured to decrypt the shared password with the decrypted shared password key obtained from the temporary service identifier structure and grant access to the client in response to the shared password if the access limit is set and the current date is not greater than the date limit in the temporary service identifier structure.

5. The apparatus of claim 1, wherein the encryption module requests a new service structure key and encrypts the service identifier structure with the new service structure key when the password policy is satisfied, the storage module stores the newly encrypted service identifier structure in the secure key structure, and the I/O module securely communicates the new service structure key to the trusted server.

6. A computer program product comprising a computer useable medium having a computer readable program, wherein the computer readable program when executed on a computer causes the computer to:
store an account identifier, a servicer identifier that identifies a servicer, a server identifier for a trusted server, a shared password key encrypted with a service structure key, a shared password encrypted with the shared password key, and a service identifier structure within a secure key structure of a client wherein the service structure key comprises a password policy for accessing data within the secure key structure and the service identifier structure comprises the shared password key;
store the service structure key encrypted with a key derived from a service password on the trusted server;
access the trusted server from the client using the server identifier in response to receiving the account identifier, the servicer identifier, and a prospective service password at the client;
receive at the client the encrypted service structure key, an access limit, and a date limit from the trusted server if a hash of the prospective service password is equivalent to a service password maintained on the trusted server; and
decrypt the encrypted service structure key at the client using the prospective

7. The computer program product of claim 6, wherein if the access limit and the date limit are configured for a single access, the computer readable code is further configured to cause the computer to:
decrypt the encrypted shared password key from the service identifier structure with the decrypted service structure key;
decrypt the shared password with the decrypted shared password key; and
grant access to the client in response to the shared password.

8. The computer program product of claim 6, wherein if the access limit and the date limit are configured for multiple accesses, the computer readable code is further configured to cause the computer to:
decrypt the encrypted service identifier structure with the decrypted service structure key;
create a temporary service identifier structure with the shared password key from the service identifier structure;
store the access limit and the date limit within the temporary service identifier structure;
store the temporary service identifier structure encrypted with the prospective service password;
decrypt the encrypted shared password key from the temporary service identifier structure with the prospective service password;
decrypt the shared password with the decrypted shared password key; and
grant access to the client in response to the shared password.

9. The computer program product of claim 8, wherein the computer readable code is further configured to cause the computer to:
receive the prospective service password entered by the servicer;
decrypt the shared password key by using the prospective service password to decrypt the temporary service identifier structure;
fail a boot if the shared password key and temporary service identifier structure cannot be decrypted;
decrement the access limit if the access limit is set;
clear the temporary service identifier structure and fail the boot if the access limit is not set else store the decremented access limit in the encrypted temporary service identifier structure;
clear the temporary service identifier structure and fail the boot if the current date is beyond the date limit in the temporary service identifier structure; and
decrypt the shared password with the decrypted shared password key obtained from the temporary service identifier structure and grant access to the client in response to the shared password if the access limit is set and the current date is not beyond the date limit in the temporary service identifier structure.

10. The computer program product of claim 6, wherein the computer readable code is configured to cause the computer to:
request a new service structure key when the password policy is satisfied;
encrypt the service identifier structure with the new service structure key;
store the newly encrypted service identifier structure in the secure key structure; and
securely communicate the new service structure key to the trusted server.

11. The computer program product of claim 6, wherein a server key is stored in the service identifier structure and on the trusted server and the computer readable code is further configured to cause the computer to securely communicate the new service structure key to the trusted server by:
encrypting the new service structure key with the server key;
communicating the encrypted new service structure key to the trusted server; and
decrypting the new service structure key at the trusted server with the server key.

12. The computer program product of claim 6, wherein the password policy comprises an access limit maximum.

13. The computer program product of claim 6, wherein the password policy comprises a date limit maximum.

14. The computer program product of claim 6, wherein the secure key structure is stored in nonvolatile memory.

15. A system to remotely access a shared password, the system comprising:
a trusted server comprising an account data structure;
a network in communication with the trusted server;
a client in communication with the trusted server over the network, the client comprising
a secure key structure;
a storage module configured to store an account identifier, a servicer identifier that identifies a servicer, a server identifier for the trusted server, a shared password key encrypted with a service structure key, a shared password encrypted with the shared password key, and a service identifier structure within the secure key structure of a client wherein the secure key structure comprises a password policy for accessing data within the secure key structure and the service identifier structure comprises the shared password key, the storage module further configured to store the service structure key encrypted with a key derived from a service password in the account data structure;
an I/O module configured to access the trusted server from the client using the server identifier in response to receiving the account identifier, the servicer identifier and a prospective service password at the client and receive at the client the encrypted service structure key, an access limit, and a date limit from the trusted server if a hash of the prospective service password is equivalent to the service password maintained on the trusted server; and
an encryption module configured to decrypt the encrypted service structure key at the client using the prospective service password.

16. The system of claim 15, wherein the encryption module is further configured to decrypt the encrypted shared password key from the service identifier structure with the decrypted service structure key, decrypt the shared password with the decrypted shared password key, and grant access to the client in response to the shared password if the access limit and the date limit are configured for a single access.

17. The system of claim 15, the system further comprising a structure module, and wherein the encryption module is further configured to decrypt the encrypted service identifier structure with the decrypted service structure key, the structure module is configured to create a temporary service identifier structure with the shared password key from the service identifier structure, the storage module is further configured to store the access limit and the date limit within the temporary service identifier structure and store the temporary service identifier structure encrypted with the prospective service password, and the encryption module is configured to decrypt the encrypted shared password key from the temporary service identifier structure with the prospective service password, decrypt the shared password with the decrypted shared password key, and grant access to the client in response to the shared password.

18. The system of claim 17, wherein the I/O module is further configured to receive the prospective service password entered by the servicer, the encryption module is configured to decrypt the shared password key by using the prospective service password to decrypt the temporary service identifier structure, fail a boot if the shared password key and temporary service identifier structure cannot be decrypted, decrement the access limit if the access limit is set, clear the temporary service identifier structure and fail the boot if the access limit is not set else store the decremented access limit in the encrypted temporary service identifier structure, clear the temporary service identifier structure and fail the boot if the current date is beyond the date limit in the temporary service identifier structure, and the encryption module is configured to decrypt the shared password with the decrypted shared password key obtained from the temporary service identifier structure and grant access to the client in response to the shared password if the access limit is set and the current date is not beyond the date limit in the temporary service identifier structure.

19. The system of claim 15, wherein the encryption module requests a new service structure key when the password policy is satisfied and encrypts the service identifier structure with the new service structure key, the storage module stores the newly encrypted service identifier structure in the secure key structure, and the I/O module securely communicates the new service structure key to the trusted server.

20. A method for deploying computer infrastructure, comprising integrating computer-readable code into a computing system, wherein the code in combination with the computing system is capable of performing the following:
storing an account identifier, a servicer identifier that identifies a servicer, a server identifier for a trusted server, a shared password key encrypted with a service structure key, a shared password encrypted with the shared password key, and a service identifier structure within a secure key structure of a client wherein the service structure key comprises a password policy for accessing data within the secure key structure and the service identifier structure comprises the shared password key;
storing the service structure key encrypted with a key derived from a service password on the trusted server;
accessing the trusted server from the client using the server identifier in response to receiving the account identifier, the servicer identifier and a prospective service password at the client;
receiving at the client the encrypted service structure key, an access limit, and a date limit from the trusted server if a hash of the prospective service password is equivalent to the service password maintained on the trusted server;
decrypting the encrypted service structure key at the client using the prospective service password;
decrypting the encrypted shared password key from the service identifier structure with the decrypted service structure key;
decrypting the shared password with the decrypted shared password key; and
granting access to the client in response to the shared password.
